(19) United States
(12) Patent Application Publication
(10) Pub. No.: US 2014/0251190 A1
(43) Pub. Date: Sep. 11, 2014

(54) Pallet Support Shield

(71) Applicant: GREEN LINE ARMOR LLC, Quincy, IL (US)

(72) Inventor: Robert Kessler, Augusta, IL (US)

(73) Assignee: GREEN LINE ARMOR LLC, Quincy, IL (US)

(21) Appl. No.: 13/790,431

(22) Filed: Mar. 8, 2013

(51) Int. Cl. B65D 19/38; B23P 6/00; B65D 19/18

(52) U.S. Cl. CPC B65D 19/38; B65D 19/18; B23P 6/00
USPC 108/57.25; 108/51.11; 29/402.09; 29/402.14; 29/402.15

(57) ABSTRACT

A reliable, light, inexpensive, and durable support shield for wooden pallets that protects the entry points of wooden pallets from the exterior pallet damage traditionally associated with pallet/forklift interaction.

### BACKGROUND OF THE INVENTION

1. Field of the Invention

This disclosure is related to the field of devices for supporting, protecting and strengthening pallets during the transport of goods.

2. Description of Related Art

Pallets, also known as skids, are ubiquitous in modern transportation and warehouse environments. Pallets are utilized to ship products efficiently with minimal damage to the goods thereon. The use of pallets in the transportation space was triggered by the use of large containers (such as shipping containers and train cars) in transportation and their smooth, level surfaces.

Although they can take many forms and be comprised of different materials, pallets are generally flat transport structures that support goods in a stable fashion while the goods are being lifted by a forklift, handtruck, pallet jack, front loader or other jacking or lifting device. In sum, a pallet forms the structural foundation of a unit load which allows for the handling and storage of goods—goods or shipping containers are often placed on a pallet, secured thereon, and then moved or shipped. Thus, pallets make it easier to move and transport heavy stacks.

In the modern transportation economy, there are over half a billion pallets made each year and there are about two billion pallets in use across the United States alone. The organizations that utilize pallets for their transportation needs can have much lower costs for handling and storage, and usually also realize a cost advantage that comes from faster material movement.

While pallets can come in a wide variety of sizes and configurations, pallets generally fall into two very broad categories: “stringer” pallets and “block” pallets. Stringer pallets have a structure of three or more parallel stringers. Top deckboards are then affixed to the stringers to create the pallet structure. Bottom deckboards can also be affixed to the stringers to increase the stability of the pallet structure. Block pallets utilize both parallel and perpendicular stringers to better facilitate efficient handling by adding lines of support in two directions on the pallet. Contrary to stringer pallets, block pallets can be lifted on all four sides.

Pallets are generally comprised of either wood, metal or plastic. Metal pallets, while strong and durable, make up less than about 1% of the market because of their high initial price, susceptibility to rusting, and high weight. Plastic pallets are widely used in the industry but, despite their durability advantage, are not the dominate material used in pallets due to their high initial cost.

Traditional pallets comprised of wood constitute the largest percentage of pallets. Wooden pallets have the advantage of low cost and low weight. Wooden pallets usually cost about $9.00-$10.00 dollars each, plus the overhead costs of shipping, storing and handling the pallets. While inexpensive and efficient, wooden pallets are often and easily damaged by forklifts during transport. For example, the forklift can split, crack and cut into the deckboards or the stringers of a wooden pallet. Further, the corners of the pallet can become damaged through dropping or undesired contact of the edges with structures during transport. One big problem in the prior art is keeping pallets square. Generally, transport of pallets is adversely affected when the pallets lose their square shape. Pallets commonly lose their square orientation through impact or the corners getting hit in transport.

Generally, roughly 50% of wooden pallets are damaged after their first trip. Further, once damaged a wooden pallet generally loses about 70% of its value. In addition to lowering the value of the pallet itself, pallet damage can damage the product being transported, whether bagged, boxed or canned. In addition to damage to the transported product and the pallet, pallet damage can have additional negative economic ramifications by increasing the time it takes to transport goods. In sum, losses stemming from pallet damage can lead to tens of millions of dollars in lost product and efficiency per year for a company.

Accordingly, there is a need in the art of pallet transport for a reliable, light, inexpensive, and durable support shield for wooden pallets that would protect the entry points of the wooden pallets from the exterior pallet damage traditionally associated with pallet/forklift interaction.

### SUMMARY OF THE INVENTION

Because of these and other problems in the art, described herein, among other things, is a reliable, light, inexpensive, and durable support shield for wooden pallets that protects the entry points of wooden pallets from the exterior pallet damage traditionally associated with pallet/forklift interaction.

In one embodiment of the pallet support shield, the pallet support shield comprises: an exterior frame, the exterior frame having an open side and a closed side; the open side of the exterior frame having one or more slots; the closed side of the exterior frame having one or more tong openings; wherein the open side of the pallet support receives a terminating end of a pallet comprised of deckboards, sideboards, runners and stringers.

In another embodiment of the pallet support shield, the one or more tong openings extend into the runners of the pallet. In still another embodiment, the one or more tong openings cover less than half the width of the deckboards which comprise the runners at the terminating end of the pallet.

It is also contemplated that one embodiment of the pallet support shield is further comprised of edges, wherein the edges cover at least a portion of the deckboards and sideboards of the pallet support shield. In one option, the edges of the pallet support shield will be of an equal width.

In another embodiment, the pallet support shield is sized and shaped to fit over the terminating end of the pallet.

In still a further embodiment it is contemplated that the pallet support shield is comprised of a composite material. One contemplated composite material is a fiber reinforced polymer. Further, in an additional embodiment, the pallet support shield is injection molded.

Also disclosed herein is a method for reinforcing a pallet with a pallet support, the method comprising: providing a pallet, the pallet having at least one terminating end; providing a pallet support shield, the pallet support shield comprising: an exterior frame, the exterior frame having an open side and a closed side; the open side of the exterior frame having one or more slots; the closed side of the exterior frame having one or more tong openings; and inserting the pallet support shield into the at least one terminating end of the pallet.

In one contemplated embodiment, the method will further comprise the step of fastening the pallet support shield to the at least one terminating end of the pallet. Contemplated fastening mechanisms can be chosen from the group consisting of: screws, nails and hooks.

### BRIEF DESCRIPTION OF THE DRAWINGS

FIG. 1 provides a perspective view of an embodiment of the pallet support shield.

FIG. 2 provides a perspective view of an embodiment of the pallet support shield on a pallet.

FIG. 3 provides a side perspective view of an embodiment of the pallet support shield on a pallet.

FIG. 4 provides a bottom perspective view of an embodiment of the pallet support shield on a pallet.

FIG. 5 provides a perspective view of another embodiment of the pallet support shield.

FIG. 6 provides a perspective view of another embodiment of the pallet support shield.

### DESCRIPTION OF THE PREFERRED EMBODIMENT(S)

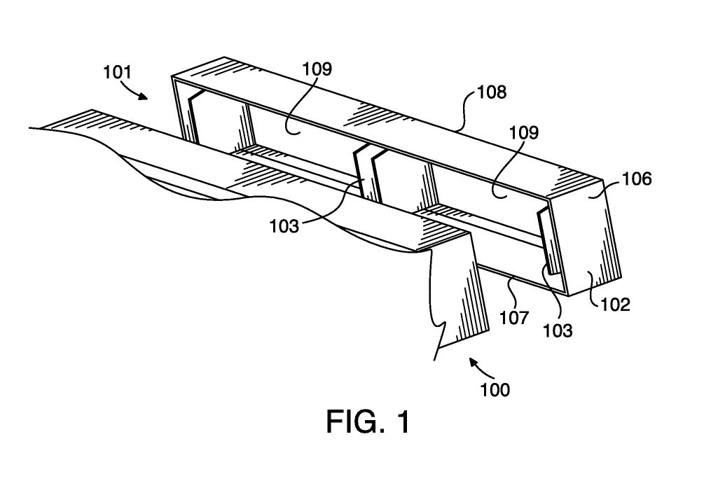

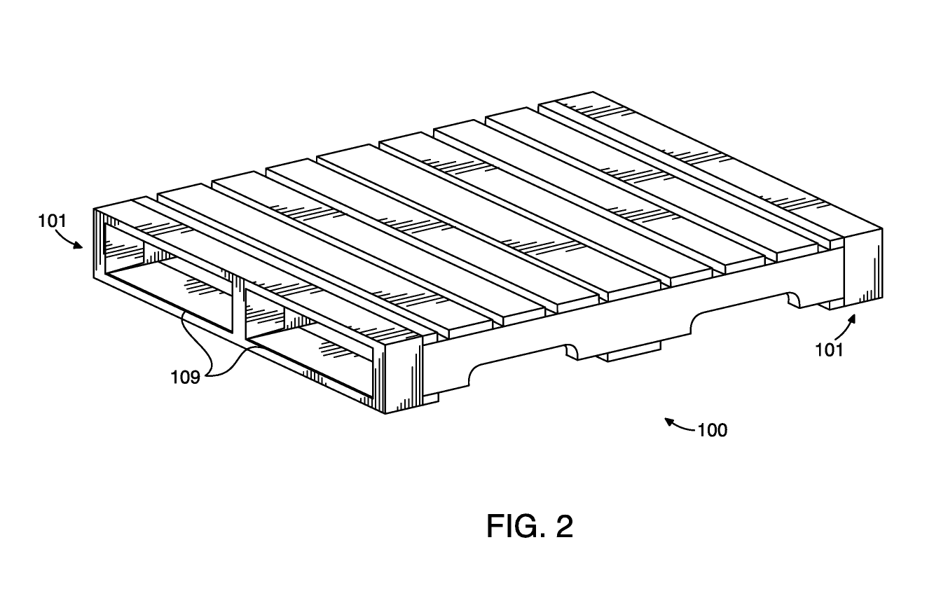

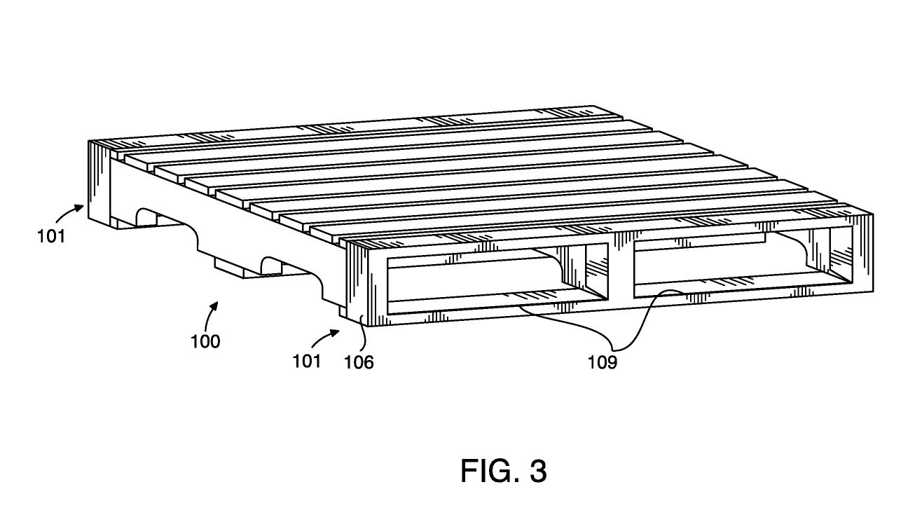

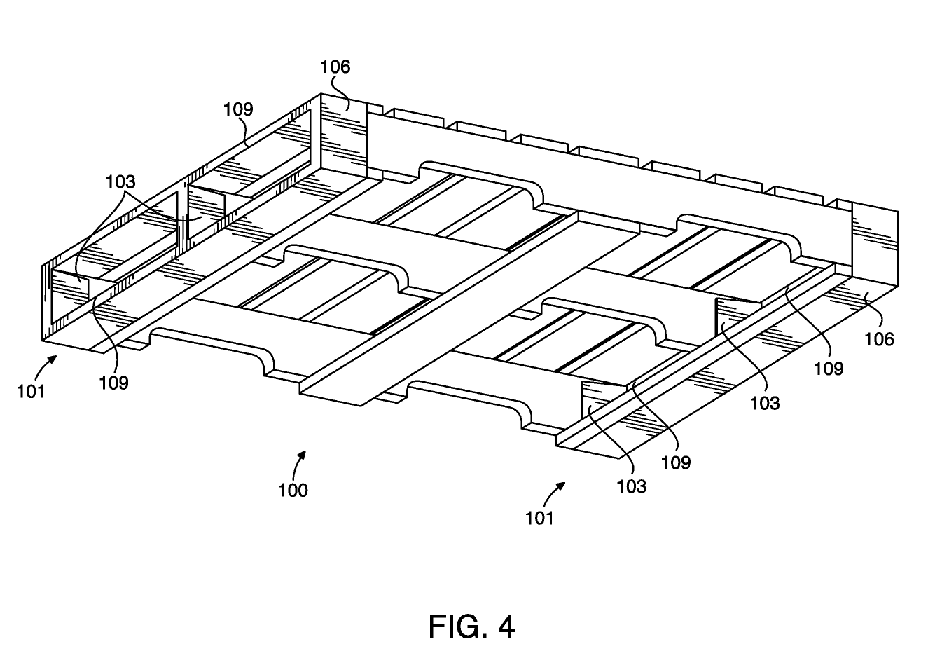

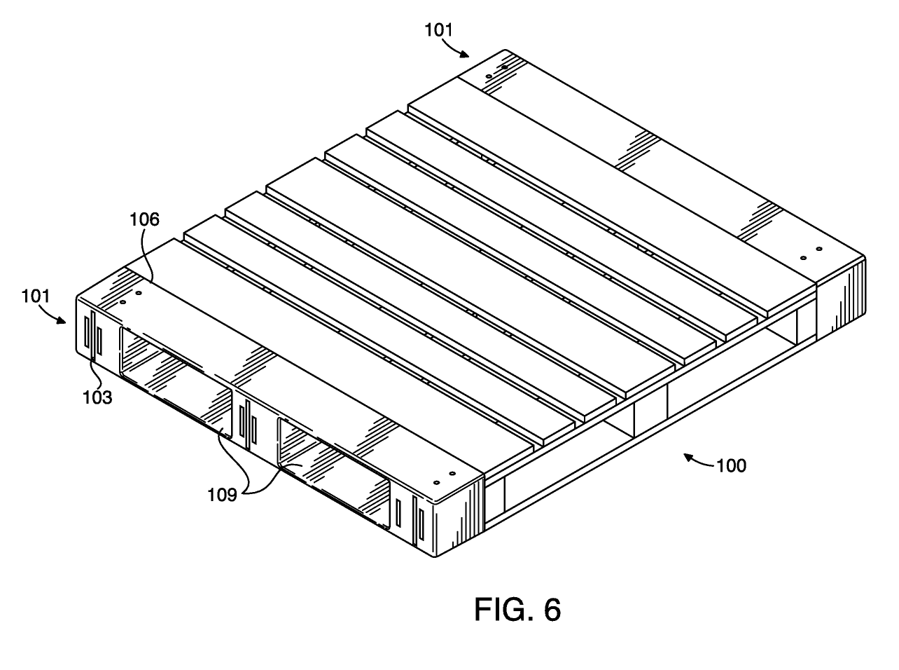

FIGS. 1-6 provide prospective views of various embodiments of a pallet support shield (101). In general, the pallet support shield (101) comprises an exterior frame (102). In each of the various embodiments disclosed herein, the exterior frame (102) of the pallet support shield (101) will be sized and shaped to correspond to a terminating end of a pallet (100). As the term is used herein, the terminating end of a pallet (100) shall mean any of the four peripheral ends of a pallet where the stringers and/or bottom and top deckboards end.

As depicted in FIGS. 1-5, the exterior frame (102) of the pallet support shield (101) corresponds to the terminating end of the pallet (100) in such a manner that, when placed onto the terminating end of a pallet (100), the exterior frame (102) of the pallet support shield (101) encapsulates the exposed portion of the pallet (100) stringers and deckboards at the pallet's (100) terminating end. Thus, when the pallet support shield (101) is attached to a pallet (100), the terminating ends of the pallet's (100) stringers are covered. Further, a portion of the exterior frame (102) extends into and covers a portion of the runners of the pallet (100). In addition, in alternative embodiments of the pallet support shield (101), a portion of the exterior perimeter of the pallet's (100) terminating ends, including the top and bottom deckboards and the lateral side boards, are covered by the edges (106) of the pallet support shield (101). Thus, in these embodiments, the two (2) corners of the terminating end of the pallet (100) to which the pallet support shield (101) is attached are covered and encapsulated.

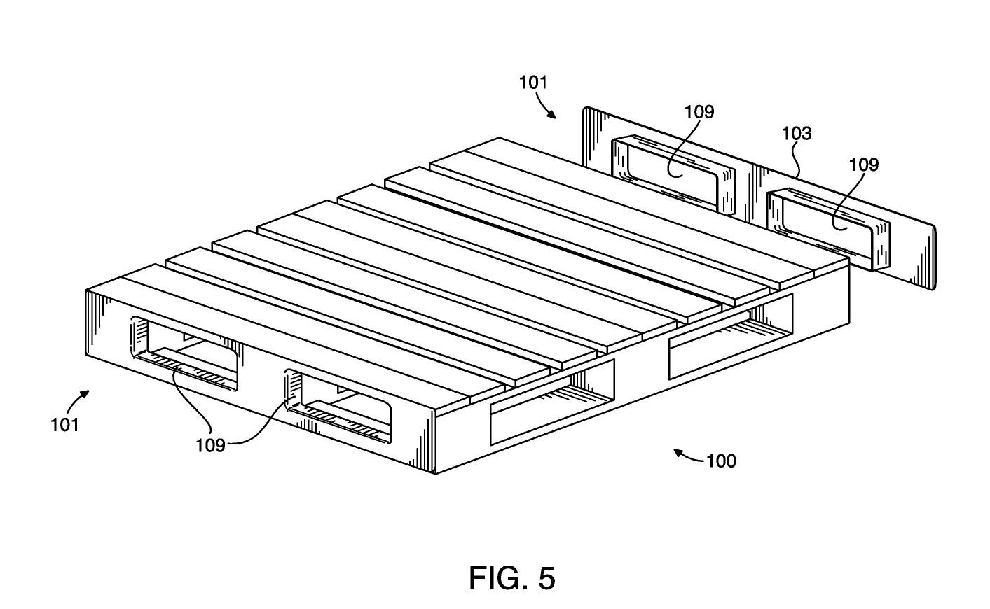

In general, the exterior frame (102) of the pallet support shield (101) has an open side (107) and a closed side (108). The open side (107) of the exterior frame (102) of the pallet support shield (101) is the side of the pallet support shield (101) which receives and is attached to a pallet, in a manner as described herein. In one embodiment of the pallet support shield (100), as depicted in FIGS. 1-4, the open side (107) of the pallet support shield (101) has a plurality of slots (103). These slots (103) are open on the open side (107) of the pallet support shield (101) in order to receive the stringers of the pallet (100). In another embodiment of the pallet support shield (101), as depicted in FIG. 5, the pallet support shield (101) has a face place orientation and the open side (107) of the pallet support shield (101) comprises the portion of the pallet support shield (101) with one slot (103) and tong openings (109) extensions.

The closed side (108) of the pallet support shield (101) encapsulates or covers the pallet's (100) terminating end and limits the insertion of the pallet (100), as depicted in FIGS. 1-5. The closed side (108) of the pallet support shield (101) has one or more tong openings (109). These tong openings (109) comprise openings in the exterior frame which correspond to the runners of the pallet (100); i.e., the channels between the stringers which comprise the pallet (100).

In one embodiment of the pallet support shield (101), depicted in FIGS. 1-4, the pallet support shield (101) is attached to the pallet via one or more slots (103). In the embodiment depicted in FIGS. 1-4, the pallet support shield (101) has three slots (103). The number of slots (103) on the pallet support shield (101) is not determinative. Generally, the number of slots (103) on the pallet support shield (101) will correspond to the number of exposed stringers for the terminating end of the pallet (100) onto which the pallet support shield (101) will be attached.

The slots (103) of this embodiment of the pallet support shield (101) correspond in width, position and structure to the pallet (100) stringers at the terminating ends of the pallet (100). Thus, when inserted onto the terminating end of a pallet (100), the slots (103) cover and are placed over the terminating ends of the stringers. In addition to covering the terminating ends of the stringers, as seen in FIGS. 1-4, the side walls of the slots (103) extend into the runners and cover a portion of the length of the stringer (which corresponds to the vertical side walls of the pallet (100) runners). Thus, the slots (103) also provide a protective cover for that covered vertical portion of the stringer.

In addition to covering the terminating exposed portion of the stringers, the exterior frame (102) of the embodiment of the pallet support shield (101) depicted in FIGS. 1-4 has edges (106) that extend along the exterior perimeter of the pallet support shield (101). As depicted in FIGS. 1-4, these edges (106) extend out from the open side (107) of the pallet support shield (101). Stated differently, the edges (106) extend over a portion of the top, bottom and sides of the terminating end of the pallet (100) onto which the pallet support shield (101) is inserted. As shown in FIGS. 1-4, the edges (106) of the pallet support shield (101) cover at least a portion of the top and bottom deckboards and at least a portion of the side panel of the pallet (100) at the terminating end of the pallet (100) onto which the pallet support shield (101) is attached. In one embodiment, it is contemplated that the edges (106) will be an equal width extending from the perimeter of the exterior frame (102) on the open side (106) of the pallet support shield (101). Thus, in this embodiment, the edges (106) will cover an equal width of the top and bottom deckboards and the sides of the pallet (100) at the terminating end to which the pallet support shield (101) is attached. For example, in one embodiment, the edges (106) will cover at least half of the width of the top and bottom deckboards and an analogous width of the side panel of the pallet (100). Generally, however, the width of the edges (106) is not determinative. Thus, while in the depicted embodiments the perimeter edges (106) that extend from the open side of the exterior frame (102) are generally the same width along its perimeter, this structure is not determinative. In alternative embodiments it is contemplated that the width of the edges (106) can be different at various points along the perimeter of the exterior frame (102).

In the embodiments depicted in FIGS. 1-4, in particular as depicted in FIG. 1, the pallet support shield (101) is sized and shaped to fit over the terminating end of the pallet (100). Stated differently, no modifications (e.g., removal or alteration of the deckboards) need to occur to insert the pallet support shield (101) onto the pallet (100), it simply fits over the existing stringers and deckboards that comprise the terminating end to which it will attach.

In an alternative embodiment of the pallet support shield (101), the pallet (100) is cut back from its original dimensions (i.e., the pallet is cut back totally) and the pallet support shield (101) is attached to the “new” face of the pallet (100) produced at the cut end.

Further, in still another embodiment, the first top and bottom deckboards on the terminating end of the pallet (100) are removed and then the remaining top and bottom deckboards are cut ¼ inch (or other dimension which corresponds to the face depth of the pallet support shield (101) to be placed on the pallet (100)) from each end prior to placement of the pallet support shield (101) onto the pallet (100). The reason for this embodiment is to retain the original dimensions of the pallet (100) even with the addition of the pallet support shield (101). Because the end cap of the pallet support shield (101) has a certain face depth, after removal of the first top and bottom deckboards from the terminating end of the pallet (100), the remaining second top and bottom deckboards need to be modified in some manner to accommodate the face depth of the pallet support shield (101) without increasing the dimension of the pallet (100). An example of how such a retrofit would occur follows. First, the top and bottom deckboards on the terminating end of a pallet (100) are removed. Next, the remaining second top and bottom deckboards on the terminating end of the pallet (100) where the first and second deckboards were removed are cut to remove a given width which corresponds to the width of the face depth of the pallet support shield (101). For example, in one embodiment, where the face depth of the pallet support shield (101) is ¼ inch, the second top and bottom deckboards will be cut back by ¼ inch to accommodate the depth of the face of the pallet support shield (101).

Also in this embodiment of the pallet support shield (101), the slots (103) of the pallet support shield (101) create one or more tong openings (109). In the embodiment of the pallet support shield (101) depicted in FIGS. 1-4, the three slots (103) create two tong openings (109). Generally, the tong openings (109) of the pallet support shield comprise openings within the exterior frame (102) through which the tongs of a handtruck, forklift or other lifting or moving piece of equipment can be inserted in order to move and manipulate a pallet to which the pallet support shield (101) is attached. When the pallet support shield (101) is attached to a pallet, a forklift's tongs must pass through the one or more tong openings (109) of the pallet support shield (101) when the forklift's tongs are placed within the pallet. For example, in the embodiment of pallet support shield (101) depicted in FIGS. 1-4, the tongs of a forklift would have to go through the two tong openings (109) of the pallet support shield (101) when the forklift's tongs are inserted into the pallet. In covering and encapsulating the most venerable portions of a pallet's (100) structure, the pallet support shield (101) is able to protect a pallet's (100) entry points from forklift damage.

In one embodiment of the pallet support shield (101), as shown in FIGS. 1-4, it is contemplated that the one or more tong openings (109) only extend into the runners via the vertical sides of the slots (103) which cover a length of the stringers which comprise the vertical sides of the runners. In this embodiment, the tong openings (109) do not generally extend into the runner to cover the top and bottom of the runner formed by the top and bottom deckboards. In other embodiments of the pallet support shield (101), as depicted in FIG. 5, it is contemplated that the one or more tong openings (109) will extend into the runners to cover a portion of the horizontal and vertical components of the runners. Thus, in these embodiments, the tong openings (109) will extend into the runners to cover a portion of the top and bottom deckboards which form the top and bottom of the runner in addition to extending into the runners via the vertical sides of the slots to cover a portion of the vertical sides of the runners.

In one contemplated embodiment, as depicted in FIG. 5, the tong openings (109) will extend along the horizontal components of the runners to cover no more than half the width of the terminating top and bottom deckboards. This orientation of the tong openings (109) in this embodiment resolves a problem known in the art that arises when handtrucks are utilized to move pallets. Generally, many handtrucks have wheels located at the terminating ends of the tines that are placed into the runners of a pallet (100). These wheels facilitate the placement and removal of the tines into and out of the runners during transportation of pallets (100). In embodiments of the pallet support shield (101) where the tong openings (109) extend across the entire surface area of the top and bottom deckboards that form the terminating ends of the runner, the height of the runner is increased. Forcing the wheeled tong ends over the increased height of the top and bottom deckboards at the terminating ends of the pallet in this embodiment can cause breaking or damage to the shield (101). Orienting the tongs openings (109) such that they extend along the horizontal components of the runners to cover no more than half the width of the terminating top and bottom deckboards eliminates this problem. Specifically, this type of tong damage is reduced or eliminated in the embodiment of the pallet support shield (101) depicted in FIG. 5 where the tong openings (109) extend along the horizontal components of the runners to cover no more than half the width of the terminating top and bottom deckboards because, in this embodiment, the increase in height the tong wheels must overcome to be extradited from the pallet (100) is more gradual. The wheels first go over the end of the bottom deckboard then, once cleared and drawn out further, the wheels go over the end of the tong opening (109). This elimination of the increased height of the runner lowers the probability that the tong wheels will catch on the pallet support shield (101), and thereby damage, the bottom and top deckboards which comprise the runner.

In the embodiment of the pallet support shield (101) depicted in FIG. 5, the exterior frame (102) of the pallet support shield (101) is inserted onto the terminating end of a pallet (100) mainly via the tong openings (109). In this embodiment, the tong openings (109) provide positioning for the pallet support shield (101). Stated differently, this embodiment of the pallet support shied (101) is basically a face plate design. As such, while this embodiment of the pallet support shield (101) covers and encapsulates the terminating ends of the stringer and runners of the pallet, it does not cover or encapsulate the corners of the terminating end of the pallet (100) or the top or bottom deckboards of the terminating end of the pallet via edges (106).

In general, any lightweight, durable and cost-effective material known to those of ordinary skill in the art is a material contemplated to comprise the pallet support shield (101) discussed herein. For example, plastics and other polymers, composite-based materials and metals are all contemplated. Further, in different embodiments, it is contemplated that the pallet support shield (101) can be reinforced by a methodology known to those of ordinary skill in the art such as reinforcement through fibers, ceramics, metals or polymers. In addition, it is contemplated that the pallet support shield (101) may be manufactured by hand, injection molded, compression molded, die cast, or formulated through any other methodology known to those of ordinary skill in the art.

Still further, it is contemplated that various embodiments of the pallet support shield (101) will further be comprised of a mold protection, antifungal protection and/or a fire retardant known to those of ordinary skill in the art. In addition, it is contemplated that this mold protection, antifungal protection and/or fire retardant can comprise part of the pallet support shield (101) or can be a coating or spray applied to the pallet support shield (101).

In certain embodiments, it is contemplated that the pallet support shield (101), once inserted onto the terminating end of a pallet, will be further secured to the pallet (100) through a fastening means known to those of ordinary skill in the art. Contemplated fastening means include, but are not limited to, screws, hooks, staples, nails, bolts, glue, hook and loop fastener, tape, and clips, amongst other fastening mechanisms known to those of ordinary skill in the art.

Finally, while the pallet support shield (101) discussed herein and depicted in the FIGs is generally described as a single unitary device, it should be understood that this application also contemplates pallet support shields (101) comprising two or more pieces. For example, this application also contemplates a pallet support shield (101), as described herein and as depicted in FIGS. 1-5, wherein the pallet support shield (101) comprises three separate pieces instead of a single unitary structure.

In sum, the various embodiments of the pallet support shield (101) disclosed herein provide a cheap, lightweight, easy-to-utilize and efficient methodology to protect the terminating ends of a pallet from the damage traditionally associated with transportation of bare, unprotected wooden pallets (100). For example, the various embodiments of the pallet support shield (101) discussed herein reinforce the ends of the pallet (100) to prevent unsquaring. The pallet (100) ends will still hold a square even when impacted if the pallet support shield (101) is present. Accordingly, the pallet support shield (101) discussed herein reduces the economic losses traditionally associated with wooden pallets and wooden pallet (100) damage.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A pallet support shield, the pallet support shield comprising:
an exterior frame, the exterior frame having an open side and a closed side;
the open side of the exterior frame having one or more slots;
the closed side of the exterior frame having one or more tong openings;
wherein the open side of the pallet support receives a terminating end of a wooden pallet comprised of deckboards, sideboards, runners and stringers;
wherein the pallet support shield is configured to fit over the terminating end of the pallet.

2. The pallet support shield of claim 1, wherein the one or more tong openings extend into the runners of the pallet.

3. The pallet support shield of claim 2, wherein the one or more tong openings cover less than half the width of the deckboards which comprise the runners at a the terminating end of the pallet.

4. The pallet support shield of claim 1, wherein the pallet support shield is further comprised of edges, wherein the edges cover at least a portion of the deckboards and sideboards of the pallet support shield.

5. The pallet support shield of claim 4, wherein the edges are an equal width.

6. (canceled)

7. The pallet support shield of claim 1, wherein the pallet support shield is comprised of a composite material.

8. The pallet support shield of claim 7, wherein the composite material is a fiber reinforced polymer.

9. The pallet support shield of claim 1, wherein the pallet support shield is injection molded.

10. A method for retrofitting an existing pallet with a pallet support, the method comprising:
providing a wooden pallet, the pallet having at least one terminating end, deckboards, sideboards, runners and stringers;
providing a pallet support shield, the pallet support shield comprising:
an exterior frame, the exterior frame having an open side and a closed side;
the open side of the exterior frame having one or more slots;
the closed side of the exterior frame having one or more tong openings; and
inserting the pallet support shield onto the at least one terminating end of the pallet such that the pallet support shield covers at least a portion of said stingers and said deckboards.

11. The method of claim 10, further comprising the step of fastening the pallet support shield to the at least one terminating end of the pallet.

12. The method of claim 11, wherein the pallet support shield is fastened to the terminating end of the pallet via a fastening mechanism chosen from the group consisting of: screws, nails and hooks.

13. The method of claim 10, wherein the one or more tong openings extend into the runners of the pallet.

14. The method of claim 13, wherein the one or more tong openings cover less than half the width of the deckboards which comprise the runners at the terminating end of the pallet.

15. A method for retrofitting an existing pallet with a pallet support, the method comprising:
providing a wooden pallet, the pallet having at least one terminating end, deckboards, sideboards, runners and stringers;
providing a pallet support shield, the pallet support shield comprising:
an exterior frame, the exterior frame having an open side and a closed side;
the open side of the exterior frame having one or more slots;
the closed side of the exterior frame having one or more tong openings which extend into the runners of the pallet and cover less than half the width of the deckboards which comprise the runners at the terminating end of the pallet;
a length between the open side and closed side; and
cutting the at least one terminating end of the pallet by the dimension identical to that of said length between the open side and closed side thereby constructing a modified terminating end of the pallet; and
inserting the pallet support shield onto the modified terminating end of the pallet such that the pallet support shield covers at least a portion of said stingers and said deckboards.
